(19) United States
(12) Patent Application Publication
(10) Pub. No.: US 2012/0099241 A1
(43) Pub. Date: Apr. 26, 2012

(54) MULTILAYER CERAMIC ELECTRONIC COMPONENTS AND METHOD OF MANUFACTURING THE SAME

(75) Inventors: Dong Ik Chang, Suwon (KR); Kang Heon Hur, Seongnam (KR); Doo Young Kim, Yongin (KR); Ji Hun Jeong, Suwon (KR)

(73) Assignee: SAMSUNG ELECTRO-MECHANICS CO., LTD.

(21) Appl. No.: 13/149,246

(22) Filed: May 31, 2011

(30) Foreign Application Priority Data
Oct. 26, 2010 (KR) 10-2010-0104836

(51) Int. Cl. H01G 4/30; H01G 7/00

(52) U.S. Cl. 361/301.4; 29/25.41

(57) ABSTRACT

Disclosed are a multilayer ceramic electronic component and a method of manufacturing the same. There is provided a multilayer ceramic electronic component, including: a ceramic main body in which a plurality of dielectric layers having an average thickness of 1 μm or less are stacked; and inner electrode layers formed on the dielectric layers and having connectivity of 90% or more expressed by the following Equation, wherein the ratio of the thickness of the inner electrode layer to the thickness of the dielectric layer is between 0.8:1 and 1.3:1. The Equation is as follows.

$$CONNECTIVITY = \frac{\begin{matrix}TOTAL LENGTH ( B ) OF CROSS SECTION \\ FORMED WITH CONDUCTIVE PASTE\end{matrix}}{\begin{matrix}TOTAL LENGTH ( A ) OF CORSS \\ SECTION OF INNER ELECTRODE\end{matrix}}$$

The high-capacity multilayer ceramic electronic component having the excellent reliability while resisting the thermal impact cracks can be provided, by having the uniform thickness of the dielectric layers to improve the voltage-resistant characteristics while implementing the high capacitance.

### CROSS-REFERENCE TO RELATED APPLICATIONS

This application claims the priority of Korean Patent Application No. 2010-0104836 filed on Oct. 26, 2010, in the Korean Intellectual Property Office, the disclosure of which is incorporated herein by reference.

### BACKGROUND OF THE INVENTION

1. Field of the Invention

The present invention relates to multilayer ceramic electronic components and a method of manufacturing the same, and more particularly, to multilayer ceramic electronic components having excellent reliability and resistance to thermal impact cracks, and a method of manufacturing the same.

2. Description of the Related Art

Generally, a multilayer ceramic capacitor (MLCC) is a chip-type condenser mounted on a printed circuit board for use in various electronic products such as mobile communications terminals, notebook (or laptop) computers, desktop computers, personal digital assistants (PDA), and the like, to perform an important role in storing and discharging electricity, and that may have various sizes and stacking types according to the usage and capacity thereof.

Recently, as electronic products tend to be miniaturized, demand for compact, high-capacity multilayer ceramic electronic components has increased. Therefore, various methods of thinning and multi-layering dielectrics and inner electrodes have been attempted. Recently, a multilayer ceramic electronic component, having an increased number of thinned stacked layers has been manufactured.

In order to implement high capacity, attempts to increase the number of stacked layers by reducing the thickness of dielectric and inner electrode layers have been generally conducted. However, as the thickness of dielectric and inner electrode layers is reduced, the thickness of inner electrode layers becomes non-uniform and the inner electrode layers may be partially disconnected while the thickness of electrode layers is continuously maintained, such that connectivity therebetween is degraded.

The inner electrodes may not be continuously connected but partially disconnected, such that they are disconnected. As a result, the capacitance of the inner electrodes is reduced due to the reduction in the area of the inner electrodes equal to the amount by which inner electrodes are disconnected. Further, the area distribution is increased according to the disconnection of the electrodes and the distribution of capacitance is increased accordingly, thereby degrading the manufacturing yield of the multilayer ceramic capacitor.

Due to the disconnection of the inner electrodes, the average thickness of the dielectric layers are the same, but portion in which the thickness thereof varies are generated, such that the insulating characteristics are degraded in a portion in which the dielectric layer is thin, thereby degrading the reliability of the multilayer ceramic capacitor.

### SUMMARY OF THE INVENTION

An aspect of the present invention provides a multilayer ceramic electronic component having excellent reliability while resisting thermal impact cracks by having the ratio of the thickness of inner electrodes to the thickness of dielectrics and the thickness of dielectric layers therein controlled, and a method of manufacturing the same.

According to an aspect of the present invention, there is provided a multilayer ceramic electronic component, including: a ceramic main body in which a plurality of dielectric layers having an average thickness of 1 μm or less are stacked; and inner electrode layers formed on the dielectric layers and having connectivity of 90% or more expressed by the following Equation, wherein the ratio of the thickness of the inner electrode layer to the thickness of the dielectric layer is between 0.8:1 and 1.3:1.

$$CONNECTIVITY = \frac{\begin{matrix}TOTAL LENGTH ( B ) OF CROSS SECTION \\ FORMED WITH CONDUCTIVE PASTE\end{matrix}}{\begin{matrix}TOTAL LENGTH ( A ) OF CORSS \\ SECTION OF INNER ELECTRODE\end{matrix}}$$

The connectivity of the inner electrode layers may be implemented by changing a particle size of a nickel metal powder in a conductive paste forming the inner electrode.

The average particle size of the nickel metal powders may be 0.05 to 0.3 μm.

The amount of organic material may be 5 to 20 parts by weight per 100 parts by weight of the conductive paste.

The amount of ceramic may be 3 to 30 parts by weight per 100 parts by weight of the conductive paste.

According to another aspect of the present invention, there is provided a method of manufacturing a multilayer ceramic electronic component, including: preparing a plurality of dielectric layers having an average thickness of 1 μm or less; and applying inner electrode layers having connectivity of 90% or more expressed by the following Equation, to the dielectric layers; and controlling the ratio of the thickness of the inner electrode layer to the thickness of the dielectric layer is controlled to be between 0.8:1 and 1.3:1 while stacking the plurality of dielectric layers applied with the inner electrode layers. The Equation is as follows.

$$CONNECTIVITY = \frac{\begin{matrix}TOTAL LENGTH ( B ) OF CROSS SECTION \\ FORMED WITH CONDUCTIVE PASTE\end{matrix}}{\begin{matrix}TOTAL LENGTH ( A ) OF CORSS \\ SECTION OF INNER ELECTRODE\end{matrix}}$$

### BRIEF DESCRIPTION OF THE DRAWINGS

The above and other aspects, features and other advantages of the present invention will be more clearly understood from the following detailed description taken in conjunction with the accompanying drawings, in which:

FIG. 1 illustrates a cross-sectional view and an enlarged view schematically showing a multilayer ceramic electronic component;

FIG. 2 illustrates a cross-sectional view and an enlarged view of a multilayer ceramic electronic component showing the thickness of inner electrode layers and the thickness of dielectric layers according to an exemplary embodiment of the present invention; and

FIG. 3 shows a manufacturing process of multilayer ceramic components according to another exemplary embodiment of the present invention.

### DETAILED DESCRIPTION OF THE PREFERRED EMBODIMENT

Hereinafter, exemplary embodiments of the present invention will be described in detail with reference to the accompanying drawings, which will fully convey the concept of the invention to those skilled in the art. Moreover, detailed descriptions related to well-known functions or configurations will be ruled out in order not to unnecessarily obscure the subject matter of the present invention. It is also noted that like reference numerals denote like elements in appreciating the drawings.

Exemplary embodiments of the present invention will now be described in detail with reference to the accompanying drawings.

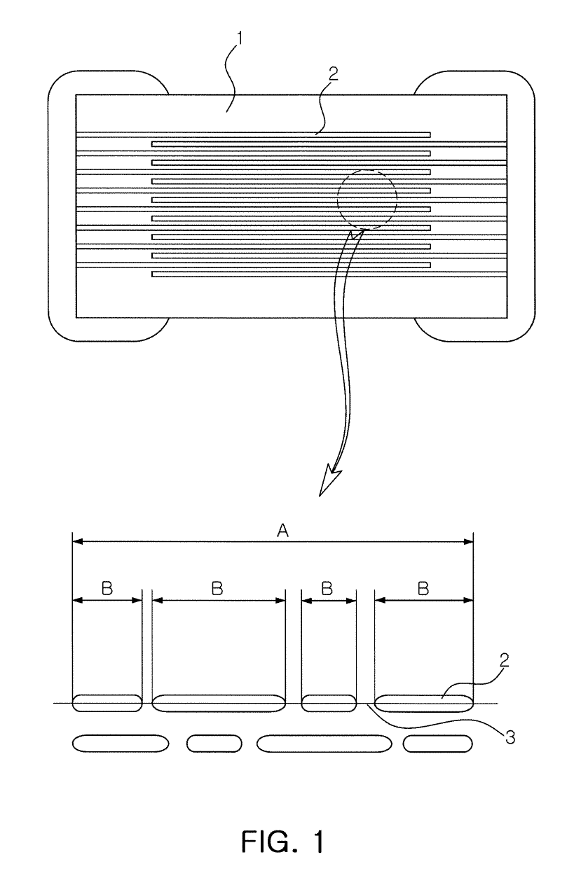

FIG. 1 illustrates a cross-sectional view and an enlarged view schematically showing multilayer ceramic electronic component.

The connectivity B/A of the inner electrode layer may be defined by a ratio of an actual total length B of a cross section applied with an inner electrode to a total length A of a cross section of an inner electrode. That is, the connectivity means the application ratio of the inner electrode, which may be defined by a ratio of an actual application area of an inner electrode to an entire area of an inner electrode.

Generally, the connectivity B/A of an inner electrode layer 2 is 65 to 75% and a portion 3 in which the inner electrode layers 2 are disconnected is void or ceramic, while the connectivity B/A of the inner electrode layer 2 of the multilayer ceramic electronic component according to the exemplary embodiment of the present invention is 90% or more.

Unlike the exemplary embodiment of the present invention, if the connectivity B/A of the inner electrode layer 2 of the multilayer ceramic electronic component is below 90%, the thickness of the dielectric layer is non-uniform, such that the voltage-resistant characteristics may be degraded.

The connectivity B/A of the inner electrode layer 2 up to 90% or more can be implemented by changing the particle size of a nickel (Ni) metal powder in a conductive paste forming the inner electrode or controlling an amount of added organic material and ceramic.

In addition, the connectivity of the inner electrode can be implemented by controlling the thickness of layers in a printing process of forming the inner electrode layer by using the conductive paste.

It is possible to control the electrode connectivity by controlling a heat rate and a firing atmosphere during a firing process.

In detail, in order to implement the connectivity B/A of the inner electrode layer 2 up to 90% or more, the connectivity of the inner electrode layer may be implemented 90% or more by controlling the average particle size of nickel metal powders in the conductive paste forming the inner electrode layer 2 to be 0.05 to 0.3 μm and controlling the amount of added organic material to be 5 to 20 parts by weight per 100 parts by weight of the conductive paste and the amount of added ceramic to be 3 to 30 parts by weight per 100 parts by weight of the conductive paste.

In the exemplary embodiment of the present invention, the average particle size of the nickel metal powders may be controlled to be 0.05 to 0.3 μm in order to secure the dispersibility of the conductive paste forming the actual inner electrodes while implementing the connectivity B/A of the inner electrode layer 2 up to 90% or more.

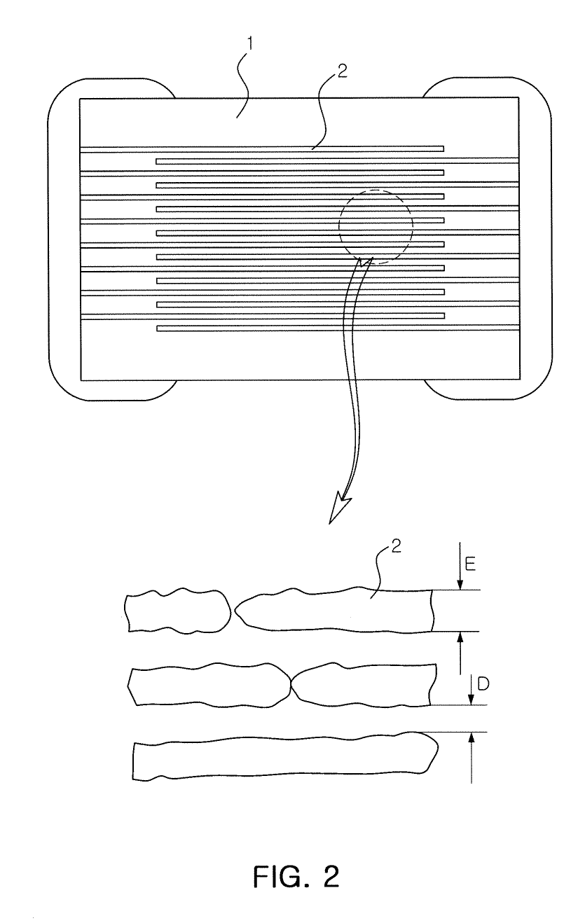

FIG. 2 illustrates a cross-sectional view and an enlarged view of multilayer ceramic electronic component showing the thickness of inner electrode layer and the thickness of dielectric layer according to an exemplary embodiment of the present invention.

According to the exemplary embodiment of the present invention, an average thickness D of dielectric layers is 1 μm or less and the ratio E/D of the thickness E of the inner electrode layer to the thickness D of the dielectric layer 1 may be between 0.8:1 and 1.3:1.

In order to implement the miniaturization and high capacity of multilayer ceramic components, the thickness of the dielectric layer 1 may be manufactured to be thin if possible. However, when the average thickness D of the dielectric layers 1 exceeds 1 μm, the capacitance is degraded even though the dielectric layer 1 has a relatively large dielectric constant, such that the high-capacity multilayer ceramic components may not be manufactured to be miniaturized.

Therefore, in the exemplary embodiment of the present invention, the multilayer ceramic components may be manufactured by controlling the average thickness D of the dielectric layers to be 1 μm or less.

In addition, in order to implement the miniaturization and the high capacity of the multilayer ceramic electronic components, the thickness E of the inner electrode layer 2 is also thin. However, when the thickness of the inner electrode layer is too thin, the application ratio of the inner electrode may be extremely lowered and thus, a desired opposite area may not be obtained.

Therefore, in the exemplary embodiment of the present invention, in order to obtain the high-capacity multilayer ceramic components having excellent reliability by improving the voltage-resistant characteristics and resisting thermal impact cracks by having a uniform thickness of the dielectric layers while implementing the high capacitance, the multilayer ceramic electronic component may be manufactured so that the thickness E of the inner electrode layer 2 to the thickness D of the dielectric layer 1 may have the ratio of between 0.8:1 and 1.3:1.

Meanwhile, another exemplary embodiment of the present invention provides a method of manufacturing multilayer ceramic electronic component including preparing a plurality of dielectric layers having an average thickness of 1 μm or less, applying an inner electrode layer to the dielectric layer to have the connectivity of 90% or more, and controlling the ratio of the thickness of the inner electrode to the thickness of the dielectric layer to be between 0.8:1 and 1.3:1 while stacking the plurality of dielectric layers applied with the inner electrode layers.

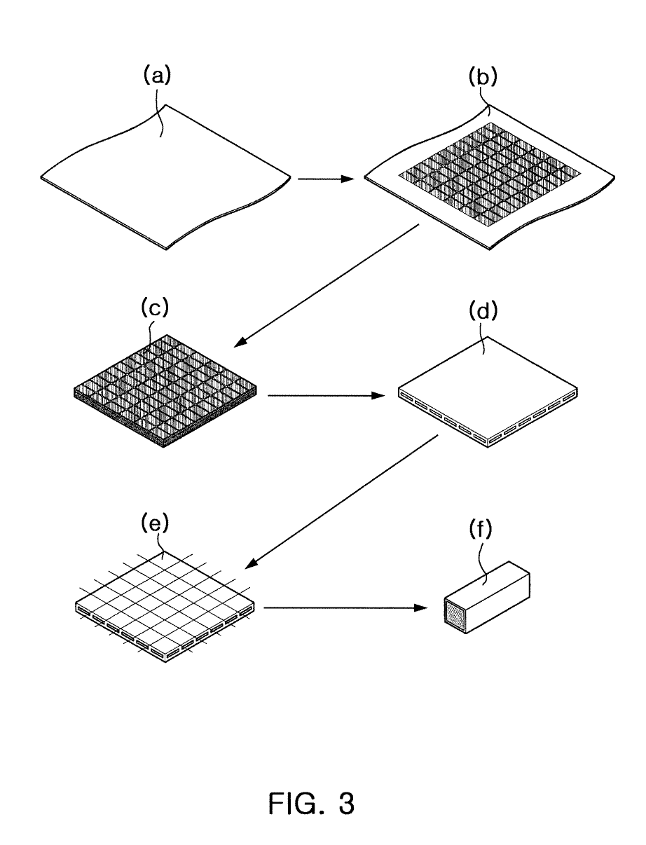

FIG. 3 shows a manufacturing process of multilayer ceramic components according to another exemplary embodiment of the present invention.

First, a plurality of green sheets may be prepared (a). In this case, the green sheet, i.e., the ceramic green sheet may be manufactured at a thickness of several μm by mixing powders such as barium titanate (BaTiO₃) with ceramic additives, an organic solvent, a plasticizer, a coupler, and a dispersant, and by applying and drying slurry formed using a basket mill to a carrier film, thereby forming the dielectric layer 1.

According to another exemplary embodiment of the present invention, the dielectric layer may be formed so that the average thickness of the dielectric layers 1 is 1 μm or less.

Further, the conductive paste may be dispensed onto the green sheet and the inner electrode layer may be formed using the conductive paste while moving the squeegee in one direction is performed (b).

In this case, the conductive paste may be made of one of precious metals such as silver (Ag), lead (Pb), platinum, or the like, nickel (Ni), and copper (Cu) or a mixture of two materials.

According to another exemplary embodiment of the present invention, the inner electrode layer 2 may be manufactured so that the connectivity B/A of the inner electrode layer 2 is implemented as 90% or more and the ratio E/D of the thickness E of the inner electrode layer 2 to the thickness D of the dielectric layer 1 is between 0.8:1 and 1.3:1.

In detail, in order to implement the connectivity B/A of the inner electrode layer 2 up to 90% or more, the connectivity of the inner electrode layer may be implemented 90% or more by controlling the average particle size of the nickel metal powders in the conductive paste forming the inner electrode layer 2 to be 0.05 to 0.3 μm and controlling the amount of added organic material to be 5 to 20 parts by weight per 100 parts by weight of the conductive paste and the amount of added ceramic to be 3 to 30 parts by weight per 100 parts by weight of the conductive paste.

As described above, after the inner electrode layer is formed, a laminate may be formed by separating the green sheet from the carrier film, and stacking the plurality of respective green sheets (c).

Then, a green chip may be manufactured by compressing (d) a green sheet laminate at high temperature and high pressure and then, cutting (e) the compressed sheet laminate in a predetermined size. As a result, the green chip may be manufactured (f).

Thereafter, a multilayer capacitor may be completed by a plasticizing process, a firing process, a polishing process, an outer electrode and plating process, or the like.

Hereinafter, the present invention is described in more detail with reference to the exemplary embodiments, but is not limited thereto.

As the conductive paste for the inner electrode, nickel having an average particle size of 0.05 to 0.2 um may be used, wherein the content of nickel may be 45 to 55%. The laminate may be manufactured by stacking 300 to 500 layers after the inner electrode is formed by a screen printing method. Thereafter, the chip having a size of 1005 standard may be manufactured by the compressing and cutting processes of the laminate, wherein the chip is fired at 1050 to 1200° C. of a reducing atmosphere of H2 of 0.1% or less. The multilayer ceramic capacitor may be manufactured by the outer electrode manufacturing, plating processes, or the like. As a result of observing the cross section of the multilayer ceramic capacitor, the average thickness of the inner electrodes may be implemented as 0.4 to 0.9 um and the thickness of the dielectric layer may be implemented as 0.3 to 0.8 um.

When the thermal impact such as mounting is applied to the ceramic laminate, the cracks may occur at the interface between the top and bottom layers of the laminate and the electrode layer due to a thermal expansion difference between the dielectric layer and the inner electrode layer. In order to resist the thermal impact cracks of the inner electrode layer and the ceramic layer, a sample having the ratio E/D of the thickness of the inner electrode to the thickness of the dielectric in the range of between 0.6:1 and 1.4:1 may be manufactured. Thereafter, the thermal impact cracks may be evaluated by a 50 to 1000 times microscope as to whether or not the cracks occur after the sample dips in solder pot of 320° C. for two seconds.

The following Table 1 indicates the number of cracks occurring due to the capacitance, the voltage resistance, and the thermal impact between Comparative Examples 1 to 6 and Inventive Examples 1 to 7, and the sample is manufactured by changing the connectivity of the inner electrode layer and the thickness ratio between the inner electrode layer and the dielectric layer by the above method.

Comparative Examples 1 to 4 indicate that the connectivity of the inner electrode is below 0.9, and Comparative Example 5 and 6 indicate that the thickness ratio of the inner electrode and the dielectric layer exceeds 1.3:1.

TABLE 1

| | Connectivity of | | Thickness Ratio (E/D) | Voltage | Thermal |
|---|---|---|---|---|---|
| | inner | Capacitance | Of Inner Electrode | Resistance | Impact |
| No. | electrode (B/A) | (uF) | And Dielectric | (V) | Crack |
| Comparative | 0.75 | 8.7 | 0.65 | 43 | 11/200 |
| Example 1 | | | | | |
| Comparative | 0.79 | 9.1 | 0.71 | 47 | 8/200 |
| Example 2 | | | | | |
| Comparative | 0.84 | 9.5 | 0.78 | 53 | 3/200 |
| Example 3 | | | | | |
| Comparative | 0.87 | 9.8 | 0.80 | 56 | 1/200 |
| Example 4 | | | | | |
| Inventive | 0.90 | 10.0 | 0.80 | 61 | 0/200 |
| Example 1 | | | | | |
| Inventive | 0.91 | 10.1 | 0.85 | 61 | 0/200 |
| Example 2 | | | | | |
| Inventive | 0.95 | 10.3 | 1.01 | 62 | 0/200 |
| Example 3 | | | | | |
| Inventive | 0.98 | 10.5 | 1.12 | 65 | 0/200 |
| Example 4 | | | | | |
| Inventive | 0.97 | 10.4 | 1.18 | 64 | 0/200 |
| Example 5 | | | | | |
| Inventive | 0.98 | 10.2 | 1.26 | 65 | 0/200 |
| Example 6 | | | | | |
| Inventive | 0.98 | 10.1 | 1.30 | 66 | 0/200 |
| Example 7 | | | | | |
| Comparative | 0.98 | 9.7 | 1.35 | 65 | 1/200 |
| Example 5 | | | | | |
| Comparative | 0.97 | 9.5 | 1.38 | 63 | 3/200 |
| Example 6 | | | | | |

As can be appreciated from the above Table 1, as the connectivity B/A of the inner electrode layer is 0.75 to 0.9 or more, the capacitance may be increased and the voltage-resistant characteristics are increased accordingly.

The thermal impact crack may be reduced in the case where the connectivity B/A of the inner electrode layer is 0.9 or more and the thickness ratio E/D of the inner electrode layer and the dielectric layer is 0.9:1 or more. When the thickness ratio of the inner electrode layer and the dielectric layer is increased, the capacitance is gradually reduced.

The reason is why when the thickness ratio of the inner electrode layer and the dielectric layer increases and thus the thickness of the green chip increases, the stacking number should be reduced.

The above Table 2 indicates the excellent voltage-resistant characteristics and the reduced thermal impact cracks while implementing the capacitance in the range that the connectivity B/A of the inner electrode layers is 0.9 or more and the thickness ratio (E/D) of the inner electrode is between 0.8:1 and 1.3:1.

As set forth above, the exemplary embodiment of the present invention can implement the high-capacity multilayer ceramic electronic component having excellent reliability while resisting thermal impact cracks by having the uniform thickness of the dielectric layers to improve the voltage-resistant characteristics while implementing the high capacitance.

While the present invention has been shown and described in connection with the exemplary embodiments, it will be apparent to those skilled in the art that modifications and variations can be made without departing from the spirit and scope of the invention as defined by the appended claims.

What is claimed is:

1. A multilayer ceramic electronic component, comprising:
a ceramic main body in which a plurality of dielectric layers having an average thickness of 1 μm or less are stacked; and
inner electrode layers formed on the dielectric layers and having connectivity of 90% or more expressed by the following Equation,
the ratio of the thickness of the inner electrode layer to the thickness of the dielectric layer being between 0.8:1 and 1.3:1.
$$CONNECTIVITY = \frac{\begin{matrix}TOTAL LENGTH ( B ) OF CROSS SECTION \\ FORMED WITH CONDUCTIVE PASTE\end{matrix}}{\begin{matrix}TOTAL LENGTH ( A ) OF CORSS \\ SECTION OF INNER ELECTRODE\end{matrix}}$$

2. The multilayer ceramic electronic component of claim 1, wherein the connectivity of the inner electrode layers is obtained by changing a particle size of a nickel metal powder in a conductive paste forming an inner electrode.

3. The multilayer ceramic electronic component of claim 2, wherein the average particle size of the nickel metal powders is 0.05 to 0.3 μm.

4. The multilayer ceramic electronic component of claim 1, wherein the connectivity of the inner electrode layer is obtained by controlling an amount of organic material and ceramic added to the conductive paste forming the inner electrode.

5. The multilayer ceramic electronic component of claim 4, wherein the amount of organic material is 5 to 20 parts by weight per 100 parts by weight of the conductive paste.

6. The multilayer ceramic electronic component of claim 4, wherein the amount of ceramic is 3 to 30 parts by weight per 100 parts by weight of the conductive paste.

7. A method of manufacturing a multilayer ceramic electronic component, comprising:
preparing a plurality of dielectric layers having an average thickness of 1 μm or less;
applying inner electrode layers having connectivity of 90% or more expressed by the following Equation to the dielectric layers, the Equation being,
$$CONNECTIVITY = \frac{\begin{matrix}TOTAL LENGTH ( B ) OF CROSS SECTION \\ FORMED WITH CONDUCTIVE PASTE\end{matrix}}{\begin{matrix}TOTAL LENGTH ( A ) OF CORSS \\ SECTION OF INNER ELECTRODE\end{matrix}} ;$$
and
controlling the ratio of the thickness of the inner electrode layer to the thickness of the dielectric layer is controlled to be between 0.8:1 and 1.3:1 while stacking the plurality of dielectric layers applied with the inner electrode layers.

8. The method of claim 7, wherein the connectivity of the inner electrode layers is obtained by changing a particle size of a nickel metal powder in a conductive paste forming the inner electrode.

9. The method of claim 8, wherein the average particle size of the nickel metal powders is 0.05 to 0.3 μm.

10. The method of claim 7, wherein the connectivity of the inner electrode layer is obtained by controlling an amount of organic material and ceramic added to the conductive paste forming the inner electrode.

11. The method of claim 10, wherein the amount of organic material is 5 to 20 parts by weight per 100 parts by weight of the conductive paste.

12. The method of claim 10, wherein the amount of ceramic is 3 to 30 parts by weight per 100 parts by weight of the conductive paste.
